(19) United States
(12) Patent Application Publication
(10) Pub. No.: US 2015/0247057 A1
(43) Pub. Date: Sep. 3, 2015

(54) POLYURETHANE DISPERSION BASED COATINGS HAVING ENHANCED REMOVABILITY

(71) Applicant: Dow Global Technologies LLC, Midland, MI (US)

(72) Inventors: Dwight Latham, Clute, TX (US); Niranjan Malvadkar, Midland, MI (US); Christopher J. Tucker, Midland, MI (US); Caroline Woelfle-Gupta, Lake Jackson, TX (US)

(21) Appl. No.: 14/422,396

(22) PCT Filed: Sep. 20, 2013
(86) PCT No.: PCT/US2013/060854

§ 371 Date: Feb. 19, 2015

Related U.S. Application Data
(60) Provisional application No. 61/704,064, filed on Sep. 21, 2012.

(51) Int. Cl. C09D 175/04

(52) U.S. Cl. CPC C09D 175/04; C08K 3/08

(57) ABSTRACT

The present invention provides a method for preparing an aqueous polyurethane dispersion comprising a polyurethane polymer, where the method comprises the step of (A) preparing a prepolymer from a reaction mixture comprising: (1) at least one polyisocyanate compound; (2) at least one polyol; and (3) ions of at least one alkali or alkaline earth metal; followed by the step of (B) contacting the prepolymer with a chain extending agent to form the polyurethane polymer. The present invention further provides an aqueous polyurethane dispersion comprising from 30% to 40%, by weight, of solids which comprise the polyurethane polymer and being prepared by the aforesaid method. A coating composition having enhanced removability and which comprises an aqueous polyurethane dispersion prepared according to the aforesaid method is also provided.

### FIELD OF THE INVENTION

The present invention relates to polyurethane dispersions useful for floor coatings that are easily removable while retaining good stability, durability and gloss characteristics. In particular, the polyurethane polymers of these dispersions have ions of at least one alkali metal incorporated therein during prepolymer synthesis, prior to final polymer preparation by chain extension.

### BACKGROUND OF THE INVENTION

In general, compositions for floor polish to be applied to floors made of wood, concrete, vinyl tiles, rubber tiles or the like are expected to form tough coatings having excellent gloss when they are applied to surfaces of floors and cured. The cured coatings, on the other hand, should be easily removed by a physical or chemical means. In addition to having gloss and being resistant to staining and scratching, the cured coatings should be detergent resistant to such an extent that gloss is not lost by treatments with ordinary detergents. The coatings should be easily removed when they reach the end of their useful lives, such as when unacceptably stained or damaged. The objectives of durability and removability are inconsistent with each other and, therefore, much effort has been spent to develop coatings which reconcile the two properties.

As explained in U.S. Pat. No. 5,912,298, floor polish formulations comprising emulsified copolymers incorporated with polyvalent metals had been previously developed, but exhibited bad odor due to vaporized amines and ammonia and were environmentally undesirable due to inclusion of heavy metal complexes such as those of zinc, cobalt, cadmium, nickel, chromium, zirconium, tin, tungsten and aluminum. Furthermore, although it was suggested in other patent literature that divalent alkaline earth metals were not suitable as cross-linking agents for polymer-based floor polish compositions, floor polish compositions based on acrylic resins (synthesized from ethylenically unsaturated monomers) were reacted and crosslinked with calcium, however these compositions did not possess the required degree of wear resistance and durability. It was also reported that coating compositions comprising aqueous polyurethane dispersions and polyvalent metal complexes were developed to address the odor and VOC issues, but still had the environmentally undesirable heavy metal issues.

Aqueous polyurethane dispersions (PUDs) are well-known as being useful in coatings and adhesives, and they have water as the primary solvent. Thus, with increased governmental regulation on the amount of volatile organic compounds (VOCs) and hazardous air pollutants (HAPs) that can be emitted into the atmosphere, PUDs are now being used in many industrial and commercial applications. In addition, their performance has improved over recent years and is now comparable to, if not better, than that of previously known solvent-based products. PUD based coatings are typically stable, easy-to-use and exhibit properties similar to solvent-based systems with respect to performance characteristics such as pre-application formulation stability, ease of use (e.g., application and curing), post-application durability, scratch resistance and appearance. PUD based coatings may be formulated as either ambient-cured (air dried) or baked coatings for application to flexible and rigid substrates, such as flooring, fabric, leather, metal, plastics and paper.

Even with normal wear and tear, whether they are ambient-cured or baked, there comes a time in their useful life when PUD based coatings must be resurfaced, or removed entirely and replaced, with one or more new layers of protective coating. Such resurfacing and replacement requires that at least the surface layer of the cured PUD based coating be removed from the substrate. This, in turn, typically requires application of a stripping formulation to disrupt the crosslinking and hydrogen bonding in the cured PUD coating, which is typically what contributes to the coating's durability and scratch resistance. While there are many types of stripping formulations useful for removing PUD coatings, regardless of which type is used, it is advantageous for the PUD coatings themselves to have characteristics which make them more easily removable, while still retaining the required degree of durability and scratch resistance for service as a protective coating.

For example, more recently, U.S. Pat. No. 5,912,298 disclosed the preparation and use of polyurethane dispersions which were successfully crosslinked with calcium, a divalent alkaline earth metal, to produce floor coatings having good durability and gloss, while being more easily removed with chemical means, e.g., stripper formulations such as those prepared by dissolving amines, alkali metal hydroxides, chelating agents, surfactants and the like in water, followed by physical rubbing with electric polishers provided with pads or the like. The aqueous polyurethane dispersions contained polyurethane polymers bearing acid functional groups such as carboxylic acid, sulfonic acid, sulfate ester, phosphate ester groups and salts thereof in their polyurethane chains and they preferably had carboxylic acid and/or carboxylic acid salt groups. Bases suitable for forming the salts were reported as amine compounds, ammonia, alkali metals and the like. However, neither the calcium nor alkali metals were incorporated directly into the polyurethane polymers during the prepolymer formation step, nor during any of the subsequent acid neutralization, dispersion in water or chain extension steps.

Experiments have been performed to study the hydrogen bonding which occurs in polyurethane polymers by using LiCl as a hydrogen bond screener. See Sheth, J. P., et al., Exploring long-range connectivity of the hard segment phase in model tri-segment oligomeric polyurethane via lithium chloride, Polymer 45 (2004), 5979-5984, and Das, S., et al., Probing the urea hard domain connectivity in segmented, non-chain extended polyureas using hydrogen-bond screening agents, Polymer 49 (2008), 174-179. More particularly, the contribution of hydrogen bonding in the hard domains of thermoplastic polyurethane resins and foams (TPUs) to the overall and long-range connectivity of the hard domains was studied. Thermoplastic polyurethane polymers are typically comprised of soft segments which provide flexibility and hard segments which provide hardness and durability to the resulting cured two-phase resins formed therefrom. The hard segments of the polyurethane polymers form crosslinks and hydrogen bonds with each other, thereby forming hard domains dispersed in a soft matrix formed by the soft segments of the cured polyurethane resin. In these experiments, a lithium ion source, anhydrous LiCl dissolved in dimethylacetate (DMAc), was mixed in varying concentrations with solutions of TPU prepolymer samples, and it was found that the LiCl interacted preferentially with the hard segments of the polyurethane polymers, thus disrupting their hydrogen bonding and formation of the hard domains in the cured resin films.

It would be useful to develop PUD based coating formulations which are more easily removed than currently known PUDs, while still having acceptable pre-application stability, low VOC content, ease of use, post-application durability, and scratch resistance. It is believed that the present invention achieves this objective by providing PUDs having alkali ions, such as lithium ions, incorporated directly into the polyurethane polymer of aqueous polyurethane dispersions used in coating formulations.

### SUMMARY OF THE INVENTION

The present invention provides a method for preparing an aqueous polyurethane dispersion comprising a polyurethane polymer. More particularly, the method comprises: (A) preparing a prepolymer from a reaction mixture comprising: (1) at least one polyisocyanate compound; (2) at least one polyol; (3) ions of at least one alkali or alkaline earth metal; and (4) optionally, at least one surfactant selected from the group consisting of a hydrophilic compound, an external surfactant, and combinations thereof. The method further comprises the step of (B) contacting the prepolymer with a chain extending agent to form the polyurethane polymer.

The ions of at least one alkali or alkaline earth metal may be monovalent or polyvalent. Preferred ions are selected from the group consisting of: lithium ions, sodium ions, potassium ions, rubidium ions, cesium ions, and combinations thereof. Especially preferred are lithium ions.

The polyisocyanate may be selected from the group consisting of: aliphatic isocyanates, aromatic isocynates, cycloaliphatic isocyanates and combinations thereof.

The at least one polyol may be selected from the group consisting of: polyester polyols, polyether polyols and polycarbonate polyols and combinations thereof.

The present invention also provides an aqueous polyurethane dispersion prepared by the aforesaid method and comprising from 30% to 40%, by weight, of solids which comprise the polyurethane polymer, based on the total weight of the aqueous polyurethane dispersion.

In some embodiments, the polyurethane polymer has an average particle size of less than 2.0 microns.

In some embodiments, the aqueous polyurethane dispersion has a viscosity of from 40 to 12,000 centipoise.

The present invention also provides a coating composition having enhanced removability and which comprises an aqueous polyurethane dispersion prepared according to the aforesaid method. In some embodiments, the ions in the reaction mixture are lithium ions.

### DETAILED DESCRIPTION OF THE INVENTION

All percentages stated herein are weight percentages (wt %), unless otherwise indicated. Temperatures are in degrees Celsius (° C.).

“Ambient temperature” means between 5° C. and 45° C., more specifically, between 5° C. and 45° C. when outdoors, and between 15° C. and 25° C. when indoors, unless specified otherwise.

“Polymer” means a polymeric compound or “resin” prepared by polymerizing monomers, whether of the same or different types. As used herein, the generic term “polymer” includes polymeric compounds made from one or more types of monomers. “Homopolymers,” as used herein means polymeric compounds which have been prepared from a single type of monomer. Similarly, “copolymers” are polymeric compounds prepared from two or more different types of monomers. For example, a polymer comprising polymerized units derived only from acrylic acid monomer is a homopolymer, while a polymer comprising polymerized units derived from methacrylic acid and butyl acrylate is a copolymer.

The term “polymerized units derived from” as used herein refers to polymer molecules that are synthesized according to polymerization techniques wherein a product polymer contains “polymerized units derived from” the constituent monomers which are the starting materials for the polymerization reactions. The proportions of constituent compounds, based on the total of all constituent compounds that are used as starting materials for a polymerization reaction are assumed to result in a polymer product having the same proportions of units derived from those respective constituent monomers. For example, where 80%, by weight, of acrylic acid monomer and 20%, by weight, of methacrylic acid monomer are provided to a polymerization reaction, the resulting polymer product will comprise 80% by weight of units derived from acrylic acid and 20% by weight of units derived from methacrylic acid. This is often written in abbreviated form as 80% AA/20% MAA. Similarly, for example, where a particular polymer is said to comprise units derived from 50% by weight acrylic acid, 40% by weight methacrylic acid, and 10% by weight itaconic acid (i.e., 50% AA/40% MAA/10% IA), then the proportions of the constituent monomers provided to the polymerization reaction can be assumed to have been 50% acrylic acid, 40% methacrylic acid and 10% itaconic acid, by weight, based on the total weight of all three constituent monomers.

The term “polyurethane” as used herein includes polymers containing linkages known to those in the art associated with the formation of a polyurethane, such as urea or polyureas, allophonate, biuret, etc.

In accordance with the present invention, the aqueous polyurethane dispersion is synthesized in at least two general steps: formation of the prepolymer and formation of the aqueous dispersion. In the first step, the prepolymer is prepared from a reaction mixture comprising at least one polyisocyanate compound, at least one polyol, and ions of at least one alkali or alkaline earth metal. Optionally, the reaction mixture may also comprise a hydrophilic compound, an external surfactant, or both. In the second step, the aqueous polyurethane dispersion is prepared by dispersing the prepolymer in water and reacting it with a chain extending agent for formation of the polyurethane.

The first step of preparing the prepolymers is performed at temperatures between about 30° C. to 190° C., preferably at about 50° C. to 120° C., preferably in the absence of a solvent. While it is generally understood in the art to be beneficial to eliminate the solvent, the prepolymer may be prepared in the presence of organic solvents, in quantities of up to about 30% by weight, based on the solids content. Suitable solvents include, for example without limitation, acetone, methyl ethyl ketone, ethyl acetoacetate, dimethyl formamide and cyclohexanone.

The at least one polyisocyanate of the prepolymer reaction mixture may be selected from the group consisting of organic polyisocyanates, modified polyisocyanates, isocyanate-based prepolymers, and mixtures thereof. These can include aliphatic, aromatic and cycloaliphatic isocyanates. Such polyisocyanates include 2,4- and 2,6-toluenediisocyanate and the corresponding isomeric mixtures; 4,4′-, 2,4′- and 2,2′-diphenyl-methanediisocyanate and the corresponding isomeric mixtures; mixtures of 4,4′-, 2,4′- and 2,2′-diphenylmethanediisocyanates and polyphenyl polymethylene polyisocyanates PMDI; and mixtures of PMDI and toluene diisocyanates. Also useful for preparing the polyurethanes of the present invention are aliphatic and cycloaliphatic isocyanate compounds such as 1,6-hexamethylene-diisocyanate; isophorone diisocyanate, 1-isocyanato-3,5,5-trimethyl-1-3-isocyanatomethyl-cyclohexane; 2,4- and 2,6-hexahydrotoluene-diisocyanate, the isomeric mixtures; 4,4′-, 2,2′- and 2,4′-dicyclohexylmethanediisocyanate, the isomeric mixtures 1,3-tetramethylene xylene diisocyanate, norbane diisocyanate and 1,3- and 1,4-bis(isocyanatomethyl)cyclohexane can also be used with the present invention.

Aliphatic isocyantates, such as isophorone diisocyanate (IPDI), and cycloaliphatic isocyanates, such as methylenedicyclohexyl diisocyanate (H12MDI), 1,3-cis bis(isocyanatomethyl)cyclohexane, 1,3-trans bis(isocyanatomethyl)cyclohexane, 1,4-cis bis(isocyanatomethyl)cyclohexane, 1,4-trans bis(isocyanatomethyl)cyclohexane and mixtures thereof are preferred. The amount of the at least one polyisocyanate present in the reaction mixture suitably ranges from about 20% to about 30%, by weight, based on the total weight of the reaction mixture (excluding solvent if present).

The term “polyol” as used herein refers to any organic compound having 2 or more hydroxyl (—OH) groups that are capable of reacting with an isocyanate group. Polyols suitable for synthesizing prepolymers useful for preparation of polyurethane dispersions are generally known to persons of ordinary skill in the art and may be selected from any of the chemical classes of polymeric polyols used or proposed for use in polyurethane formulations. The amount of the at least one polyol in the reaction mixture ranges from about 65% to about 75%, by weight, based on the total weight of the reaction mixture (excluding solvent if present). Furthermore, it is noted that any active hydrogen containing compound can be used for reaction with the polyisocyanates to form the prepolymer. Examples of such active hydrogen containing compounds include those selected from the following classes of compositions, alone or in combination with one another: (a) alkylene oxide adducts of polyhydroxyalkanes; (b) alkylene oxide adducts of non-reducing sugars and sugar derivatives; (c) alkylene oxide adducts of phosphorus and polyphosphorus acids; and (d) alkylene oxide adducts of polyphenols.

For example, suitable polyether polyols include those obtained by the alkoxylation of suitable starting molecules with an alkylene oxide, such as ethylene (EO), propylene (PO), butylene oxide (BO), or a mixture thereof. Examples of initiator molecules include water, ammonia, aniline or polyhydric alcohols such as dihyric alcohols having a molecular weight of 62-399, especially the alkane polyols such as ethylene glycol, propylene glycol, hexamethylene diol, glycerol, trimethylol propane or trimethylol ethane, or the low molecular weight alcohols containing ether groups such as diethylene glycol, triethylene glycol, dipropylene glyol, tripropylene glycol or butylene glycols. Other commonly used initiators include pentaerythritol, xylitol, arabitol, sorbitol, sucrose, mannitol, bis-phenol A and the like. Other initiators include linear and cyclic amine compounds which may also contain a tertiary amine, such as ethanoldiamine, triethanoldiamine, and various isomers of toluene diamine, methyldiphenylamine, aminoethylpiperazine, ethylenediamine, N-methyl-1,2-ethanediamine, N-methyl-1,3-propanediamine, N,N-dimethyl-1,3-diaminopropane, N,N-dimethylethanolamine, 3,3-diamino-N-methylpropylamine, aminopropyl-imidazole and mixtures thereof. Preferred are poly(propylene oxide)polyols and poly(oxypropylene-oxyethylene)polyols is used. These polyols are conventional materials prepared by conventional methods. Catalysis for this polymerization can be either anionic or cationic, with catalysts such as KOH, CsOH, boron trifluoride, or a double cyanide complex (DMC) catalyst such as zinc hexacyanocobaltate or quaternary phosphazenium compound. In the case of alkaline catalysts, these alkaline catalysts are preferably removed from the polyol at the end of production by a proper finishing step, such as coalescence, magnesium silicate separation or acid neutralization.

Other suitable polyether polyols include the poly(tetramethylene oxide)polyols, also known as poly(oxytetramethylene)glycol, that are commercially available as diols. These polyols are prepared from the cationic ring-opening of tetrahydrofuran and termination with water, and include poly(oxypropylene)glycols, triols, tetrols and hexols and any of these that are capped with ethylene oxide. These polyols also include poly(oxypropyleneoxyethylene)polyols. The oxyethylene content should preferably comprise less than about 80 weight percent of the total polyol weight and more preferably less than about 40 weight percent. The ethylene oxide, when used, can be incorporated in any way along the polymer chain, for example, as internal blocks, terminal blocks, or randomly distributed blocks, or any combination thereof.

Polyether polyols based on an aromatic polyamine include those initiated, for example, with 2,3-, 3,4-, 2,4- and 2,6-tolulenediamine, 4,4′, 2,4′- and 2,2′-diaminodiphenylmethnane, polyphenyl-polymethylene-polamines, 1,2-, 1,3- and 1,4-phenylenediamine and mixtures thereof.

Illustrative polyester polyols may be prepared from organic dicarboxylic acids having from 2 to 12 carbon atoms, preferably aromatic dicarboxylic acids having from 8 to 12 carbon atoms, and polyhydric alcohols, preferably diols, having from 2 to 12, preferably from 2 to 8 and more preferably 2 to 6 carbon atoms. Examples of dicarboxylic acids are succinic acid, glutaric acid, adipic acid, suberic acid, azelaic acid, sebacic acid, decanedicarboxylic acid, malonic acid, pimelic acid, 2-methyl-1,6-hexanoic acid, dodecanedioic acid, maleic acid and fumaric acid. Preferred aromatic dicarboxylic acids are phthalic acid, isophthalic acid, terephthalic acid and isomers of naphthalene-dicarboxylic acids. Such acids may be used individually or as mixtures. Examples of dihydric and polyhydric alcohols include ethanediol, diethylene glycol, triethylene glycol, 1,2- and 1,3-propanediol, dipropylene glycol, 1,4-butanediol and other butanediols, 1,5-pentanediol and other pentanediols, 1,6-hexanediol, 1,10-decanediol, glycerol, and trimethylolpropane. Illustrative of the polyester polyols are poly(hexanediol adipate), poly(butylene glycol adipate), poly(ethylene glycol adipate), poly(diethylene glycol adipate), poly(hexanediol oxalate), poly(ethylene glycol sebecate), and the like. For example, polyester polyols suitable for use in the present invention are commercially available under the tradename PIOTHANE from Panolam Industries International of Shelton, Conn., USA. Also, suitable linear and branched polyester polyols are commercially available under the tradename FOMREZ from Chemtura Corporation of Philadelphia, Pa., USA. Cylcoaliphatic polyols and mixtures thereof are also useful polyester polyols for making and using the present invention, such as, for example, without limitation, mixtures of (cis, trans) 1,3-cyclohexanedimethanol and (cis. trans) 1,4-cyclohexanedimethanol which are available under the tradename UNOXOL from

Another class of polyesters which may be used are polylactone polyols. Such polyols are prepared by the reaction of a lactone monomer; illustrative of which is δ-valerolactone, ε-caprolactone, ε-methyl-ε-caprolactone, ξ-enantholactone, and the like; with an initiator that has active hydrogen-containing groups; illustrative of which is ethylene glycol, diethylene glycol, propanediols, 1,4-butanediol, 1,6-hexanediol, trimethylolpropane, and the like. The preferred lactone polyols are the di-, tri-, and tetra-hydroxyl functional epsilon-caprolactone polyols known as polycaprolactone polyols.

Polycarbonate containing hydroxyl groups include those known per se such as the products obtained from the reaction of diols such as propanediol-(1,3), butanediols-(1,4) and/or hexanediol-(1,6), diethylene glycol, triethylene glycol or tetraethylene glycol with diarylcarbonates, e.g. diphenylcarbonate or phosgene. Preferred polyols of this type include linear hydroxyl-terminated aliphatic polycarbonate diols available under the tradename DESMOPHEN from Bayer MaterialScience of Pittsburgh, Pa., USA.

Illustrative of the various other polyols suitable are the styrene/allyl alcohol copolymers; alkoxylated adducts of dimethylol dicyclopentadiene; vinyl chloride/vinyl acetate/vinyl alcohol copolymers; vinyl chloride/vinyl acetate/hydroxypropyl acrylate copolymers, copolymers of 2-hydroxyethylacrylate, ethyl acrylate, and/or butyl acrylate or 2-ethylhexyl acrylate; copolymers of hydroxypropyl acrylate, ethyl acrylate, and/or butyl acrylate or 2-ethylhexylacrylate, and the like.

The ions of at least one alkali or alkaline earth metal may be monovalent or polyvalent, for example, without limitation, Group I element ions, such as lithium or sodium ions, and Group II element ions, such as magnesium, calcium or barium ions. Preferred ions are those of at least one alkali metal selected from the group consisting of: lithium ions, sodium ions, potassium ions, rubidium ions, cesium ions, and combinations thereof. More preferred alkali metal ions are lithium, sodium and potassium ions, with the most preferred being lithium ions. Without wishing to be bound by theory, it is believed that the presence of the incorporated alkali ions weakens or disrupts hydrogen bonds which otherwise form between the hard segments of polyurethane polymers. It is further believed that while the hydrogen bonds in PUD coatings add durability to the cured coating films, their disruption by the alkali metal ions makes it easier for stripping formulations to break up the crosslinking of the cured PUD films and, thereby, facilitate removal of films when desired.

The optional hydrophilic compounds suitable for preparing the prepolymer are mono- or difunctional in the context of isocyanate addition reactions that are capable of imparting some hydrophilicity to the prepolymer. More specifically, suitable hydrophilic compounds contain cationic and/or anionic hydrophilic groups and/or non-ionic hydrophilic polyoxyethylene moieties which are incorporated directly into the prepolymer. Such hydrophilic compounds include, for example without limitation, dihydroxy compounds; diamines or diisocyantes containing ionic or potential ionic groups (for example tertiary amine groups which become ammonium groups when they are acidified or alkylated), or also monoalcohols, monoamines or monoisocyanates containing polyethylene oxide units. Where present, the amount of at least one hydrophilic compound in the reaction mixture is in the range of from about 3% to about 30%, by weight, based on the total weight of the reaction mixture (excluding solvent if present), preferably from about 5% to about 20%.

When a hydrophilic compound is included in the prepolymer, prior to preparing the dispersion from the prepolymer and, preferably prior to adding water to the prepolymer to form a prepolymer dispersion, it is recommended to add one or more neutralizing agents to neutralize at least a portion of hydrophilic groups incorporated in the prepolymer. While not intending to be bound by theory, it is believed that the amount of neutralizing agent that is used is important in affecting the final aqueous polyurethane dispersion product. More particularly, it is believed that too much neutralization may result in a water soluble polymer that yields a polymer solution, rather than a dispersion. On the other hand, too little neutralization may result in an unstable dispersion. The amount of neutralizing agent added to the prepolymer present may range from about 1.75% to about 3.75%, preferably from about 1.9% to about 3.25%, and more preferably from about 2.0% to about 2.5% by weight of the reaction mixture. Suitable neutralizing agents include inorganic bases such as potassium hydroxide, lithium hydroxide, tertiary amines such as triethylamine, tri butyl amine, monoethyl di proyl amine, mono ethyl dibutyl amine, diethyl mono propyl amine, diethyl monobutyl amine etc.

An external surfactant, which may be cationic, anionic, or nonionic, may be used to prepare the aqueous prepolymer, particularly in the absence of hydrophilic compounds. Suitable extrernal surfactants include, without limitation, sulfates of ethoxylated phenols such as poly(oxy-1,2-ethanediyl)(α-sulfo-Ω-(nonylphenoxy)ammonium salt; alkali metal fatty acid salts such as alkali metal oleates and stearates; polyoxyalkylene nonionics such as polyethylene oxide, polypropylene oxide, polybutylene oxide, and copolymers thereof; alcohol alkoxylates; ethoxylated fatty acid esters and alkylphenol ethoxylates; alkali metal lauryl sulfates; amine lauryl sulfates such as triethanolamine lauryl sulfate; quaternary ammonium surfactants; alkali metal alkylbenzene sulfonates such as branched and linear sodium dodecylbenzene sulfonates; amine alkyl benzene sulfonates such as triethanolamine dodecylbenzene sulfonate; anionic and nonionic fluorocarbon surfactants such as fluorinated alkyl esters and alkali metal perfluoroalkyl sulfonates; organosilicon surfactants such as modified polydimethylsiloxanes; and alkali metal soaps of modified resins. If the prepolymer is self-emulsifying by inclusion of emulsifying (hydrophilic) nonionic, cationic, or anionic groups, then an external surfactant may or may not be advantageous, as determinable by persons of ordinary skill in the art, based on consideration of the desired viscosity and stability characteristics of the prepolymer.

The sequence of addition of the aforesaid individual components of the reaction mixture is to a large extent optional. One or more polyol compounds may be mixed and the polyisocyanate added thereto or one or a mixture of polyol compounds may be added to the polyisocyanate component or one or more polyol compounds may be added to the polyisocyanate individually one after another.

Preferably, the above-described steps for preparing the prepolymer and aqueous dispersion are performed sequentially. In alternative embodiments, however, one or more of the steps may be performed in a variety of different orders or during at least a portion of one or more steps. In certain instances, for example, the neutralizing step may be conducted during at least a portion of the reacting step, the neutralizing step may be conducted during at least a portion of the dispersing step, or the reacting step may be conducted during at least a portion of the chain extending steps, and variations thereof.

As mentioned above, in the second step of the general process for producing polyurethane dispersions, the prepolymer is dispersed in water and a chain extending agent is added thereto for formation of the polyurethane. The polyurethane dispersion producing second step is typically performed at temperatures between about 40° C. and about 90° C., preferably between about 50° C. and about 85° C.

Chain extending agents are compounds that contain functional groups that react with isocyanate groups to form urethane, urea, or thiourea groups. Generally, chain extending agents are well known in the art. Although water can be used as a chain extending agent, other chain extending agents are preferred for increasing molecular weight. Therefore, it is beneficial to contact the prepolymer with the selected chain extending agent before substantial reaction takes place between water and the prepolymer. Preferred chain extending agents include aliphatic, cycloaliphatic, aromatic polyamines, and alcohol amines. More preferred chain extending agents are alcohol monoamines, such as monoethanol amine and diethanol amine, and diamines including hydrazine, ethylene diamine, cyclohexane-1,4-dimethanol, propylene-1,2-diamine, propylene-1,3-diamine, 1,2-ethylenediamine, 1,2-propanediamine tetramethylenediamine, hexamethylenediamine, 4,4′-dimethylamino-3,3′-dimethyl-diphenylmethane, 4,4′-diamino-diphenylmethane, 2,4-diaminotoluene, 2,6-diaminotoluene, aminoethylethanolamine, and piperazine. Water-soluble diamines are preferred. Piperazine, 1,3-propanediamine, hexamethylenediamine and cyclohexane-1,4-dimethanol are examples of preferred chain extending agents.

The chain extending agent is preferably the limiting reagent because it is desirable to avoid residual chain extending agent, particularly diamine, in the final polyurethane dispersion product. Thus, in a preferred method of preparing the polyurethane dispersion, an aqueous solution of the selected chain extending agent, for example, a diamine, is contacted with a stoichiometric excess of a dispersion of the prepolymer (that is, a stoichiometric excess of isocyanate groups). After the chain extending agent is substantially completely reacted, the resulting dispersion is preferably allowed to stand for a sufficiently long time so that the remaining isocyanate groups react with the water.

In certain preferred embodiments, the at least one diisocyanate, the at least one polyol, the ions of at least one alkali or alkaline earth metal, the optional solvent, and the optional hydrophilic compound and/or external surfactant are added to a reactor at room temperature under a nitrogen atmosphere, to form the reaction mixture for producing the prepolymer. The reactor contents are then heated to one or more temperatures ranging from 50° C. to 120° C. to perform prepolymer synthesis. The reactor is then cooled to one or more temperatures less than about 50° C. One or more neutralizing agents are then added and allowed to react for a time ranging from 5 to 30 minutes or longer. In a second reactor, an appropriate amount of water to produce an aqueous dispersion containing from about 30% to about 40% by weight of solids is added. The contents of the first reactor are then added to the second reactor containing the water with sufficient agitation to produce a translucent to white dispersion. Care is taken at this point not to allow the temperature in the second reactor to go above 40° C. Once the dispersion in water step is complete, one or more chain extending agents are added to the second reactor and the contents of the reactor are heated to one or more temperatures ranging from 50° C. to 85° C., for a time ranging from 15 to 75 minutes or longer, to produce the polyurethane polymers. The contents are then cooled to about 35° C. and collected.

The aqueous polyurethane dispersion disclosed herein may comprise water and from about 20 to about 60 weight %, typically from about 30 to about 40 weight % solids wherein the solids content comprise a polyurethane polymer. The aqueous polyurethane dispersions may be further diluted to any proportion. The particle size of the polyurethane polymer molecules contained within the aqueous polyurethane dispersion is less than about 2.0 micron, preferably less than about 1.5 micron, and more preferably less than about 1 micron. The polyurethane polymer contained within the aqueous polyurethane dispersion has a theoretical free isocyanate functionality of approximately zero. The viscosity of the aqueous polyurethane dispersion may range from about 40 to about 12,000 cps, preferably about 100 to about 4,000 cps, and more preferably about 200 to about 1,200 cps. The dispersions are preferably optically opaque to transparent. The aqueous polyurethane dispersion will remain storage stable and fully dispersed within the aqueous media for extended periods of time. The T_{g} of the polyurethane dispersion may range from about −60° C. to about 10° C., as determined by DSC calorimetry.

The use, application and benefits of the present invention will be clarified by the following discussion and description of exemplary embodiments of the present invention.

### EXAMPLES

The synthesis of sample PUDs used for studying the effect of lithium ions on removability of these types of coatings was carried out using a high throughput workflow. Dispensing of prepolymer components (i.e., 70-1000 HAI, dimethylolpropionic acid, Dow ADI, and UNOXOL diol) was carried out using a Hamilton Microlab Star liquid handing robot in a nitrogen purged enclosure. Lithium salt solutions were weighed out manually prior to Hamilton dispense. After the dispensing step, vials were capped inside the nitrogen purged enclosure, removed from the enclosure and mixed using a FlackTek Inc. Speed Mixer (model DCV DAC 150 FVZ-K) for at least 60 seconds at 3000 rpm. The reaction of prepolymer components was carried out in an 80° C. oven for 4 hours while rotating at 2-4 rpm to ensure homogeneous reaction conditions. Following prepolymer synthesis, the following components were manually added to each vial:
1. triethyl amine (TEA) for neutralizing acid groups,
2. water for dispersing the particles, and
3. 1,2-diamino propane for chain extension.

After each addition step, the components in the vials were mixed using the speed mixer for at least 60 seconds at 3000 rpm. TABLE 1 gives the compositions of each of the three different example PUDs synthesized, wherein:
Polyol 1=70-1000 HAI
Polyol 2=UNOXOL, a short chain diol
Isocyanate=Dow ADI
Chain Extender=1,2-propane diamine
DMPA=dimethylolpropionic acid (hydrophilic compound)

TABLE 1
Compositions of PUDs containing
different amounts of lithium ions

| | | Li- | | | | | Chain |
|---|---|---|---|---|---|---|---|
| Sample | % Li- | ion | Polyol | Polyol | DMPA | Isocy- | Extend- |
| # | ion | type | 1 (g) | 2 (g) | (g) | anate | er |
| PUD0 | 0 | None | 2.4 | 0.63 | 0.30 | 2.415 | 0.25 |
| PUD2 | 0.15 | LiCl | 2.4 | 0.63 | 0.30 | 2.415 | 0.25 |
| PUD4 | 0.15 | LiNO₃ | 2.4 | 0.63 | 0.30 | 2.415 | 0.25 |

Once synthesized, one coat of each PUD was applied on black vinyl tiles (Armstrong) typically used in the floor care field and obtained from Home Depot. The different coating were subsequently stripped using a High Throughput scrubber developed in the Dow Liquid Formulation group using three different floor stripper formulations (317664H4, 317664H8, 317664C4) at 50 strokes/min for 1 min. The coatings were soaked for 30 min with the stripper formulation prior to scrubbing, and the formulations used as is. TABLE 2 gives the composition of the stripper formulations used.

TABLE 2
Stripper formulations used to scrub the different PUD coatings.

| | C4 | C6 | C10 | C12 | D4 | H4 | H8 | H12 |
|---|---|---|---|---|---|---|---|---|
| DPnB | 0 | 0 | 0 | 0 | 0 | 30 | 30 | 30 |
| Cyclohexane | 25 | 25 | 25 | 25 | 30 | 0 | 0 | 0 |
| 1,2-hexanediol | 30 | 15 | 15 | 30 | 30 | 30 | 30 | 30 |
| MEA | 2 | 3.5 | 5 | 5 | 2 | 2 | 5 | 5 |
| NaOH | 0.25 | | | | | 0.25 | 0.25 | |
| LAS | 7 | 7 | 7 | 7 | 7 | 7 | 7 | 7 |
| Water | 35.75 | | | | | 30.75 | 29.25 | |

TABLE 3
Percent of PUD Coating Removed for Each Sample Formulation

| | Stripper Type | | | | | | | | |
|---|---|---|---|---|---|---|---|---|---|
| Salt-% | C4 | C6 | C10 | C12 | D4 | H4 | H8 | H12 | Freedom |
| LiCl 0 | 10 | 10 | 10 | 15 | 15 | 5 | 5 | 5 | 7 |
| LiCl 0.1 | 10 | 2 | 2 | 10 | 15 | 15 | 10 | 70 | 2 |
| LiCl 0.15 | 85 | 15 | 5 | 85 | 85 | 85 | 98 | 75 | 10 |
| LiNO₃ 0 | 10 | 10 | 10 | 15 | 15 | 5 | 5 | 5 | 7 |
| LiNO₃ 0.1 | 30 | 20 | 20 | 20 | 15 | 30 | 70 | 5 | 2 |
| LiNO₃ 0.15 | 90 | 80 | 40 | 80 | 80 | 90 | 95 | 90 | 10 |

TABLE 3 shows that when 0.15% of LiCl, or 0.15% of LiNO₃ was incorporated in the prepolymer stage of the PUD synthesis, the removability of the coating was significantly improved, regardless of the type of stripper used.

What is claimed is:

1. A method for preparing an aqueous polyurethane dispersion comprising a polyurethane polymer, said method comprising:
(A) preparing a prepolymer from a reaction mixture comprising:
(1) at least one polyisocyanate compound;
(2) at least one polyol;
(3) ions of at least one alkali or alkaline earth metal; and
(4) optionally, at least one surfactant selected from the group consisting of a hydrophilic compound, an external surfactant, and combinations thereof; and
(B) contacting the prepolymer with a chain extending agent to form the polyurethane polymer.

2. The method of claim 1, wherein said ions are selected from the group consisting of: lithium ions, sodium ions, potassium ions, rubidium ions, cesium ions, and combinations thereof.

3. The method of claim 2, wherein said ions are lithium ions.

4. The method of claim 1, wherein said at least one polyisocyanate is selected from the group consisting of: aliphatic isocyanates, aromatic isocynates, cycloaliphatic isocyanates and combinations thereof.

5. The method of claim 1, wherein said at least one polyol is selected from the group consisting of: polyester polyols, polyether polyols and polycarbonate polyols and combinations thereof.

6. The method of claim 1, wherein said at least one polyisocyanate is selected from the group consisting of aliphatic polyisocyanates and mixtures thereof, said at least one polyol is selected from the group consisting of polyester polyols, and said ions comprise lithium ions.

7. An aqueous polyurethane dispersion prepared by the method of claim 1, comprising from 30% to 40%, by weight, of solids which comprise the polyurethane polymer, based on the total weight of the aqueous polyurethane dispersion.

8. The aqueous polyurethane dispersion of claim 7, wherein the polyurethane polymer has an average particle size of less than 2.0 microns.

9. The aqueous polyurethane dispersion of claim 7 having a viscosity of from 40 to 12,000 centipoise.

10. A coating composition having enhanced removability and which comprises an aqueous polyurethane dispersion prepared according to the method of claim 1.

11. The coating composition of claim 10, wherein said ions of at least one alkali metal of the reaction mixture are lithium ions.
